(19) United States
(12) Patent Application Publication
(10) Pub. No.: US 2006/0066520 A1
(43) Pub. Date: Mar. 30, 2006

(54) Plasma display panel and plasma display device

(75) Inventors: Naoki Itokawa, Kawasaki (JP); Takayuki Kobayashi, Kawasaki (JP); Takashi Sasaki, Kawasaki (JP); Tooru Teraoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU HITACH PLASMA DISPLAY LIMITED, Kawasaki (JP)

(21) Appl. No.: 11/233,037

(22) Filed: Sep. 23, 2005

(30) Foreign Application Priority Data
Sep. 24, 2004 (JP) 2004-277103

(51) Int. Cl. G09G 3/28

(52) U.S. Cl. 345/67

(57) ABSTRACT

A plasma display panel, the light emission efficiency of which has been improved without increasing the discharge start voltage, is disclosed. In a three-electrode type PDP, a fourth (Z) electrode is provided at the portion between a first (X) electrode and a second (Y) electrode between which a main discharge (a sustain discharge) is caused to occur for a display and at least one of the distance between the first electrode and the fourth electrode and the distance between the second electrode and the fourth electrode changes gradually in a cell.

### BACKGROUND OF THE INVENTION

The present invention relates to an A/C-type plasma display panel (PDP) and a plasma display device (PDP device) used as a display unit of a personal computer or a workstation, a flat TV, or a plasma display for a displaying advertisement, information, etc.

In an AC-type color PDP apparatus, an address/display separation (ADS) system is widely adopted, in which a period for specifying cells to be used for display (address period) and a display period (sustain period) for causing a discharge to occur to light cells for display are separated. In this system, charges are accumulated in the cells to be lit during the address period and a discharge is caused to occur for display during the sustain period by utilizing the charges.

Plasma display panels include: a two-electrode type PDP in which a plurality of first electrodes extending in a first direction are provided in parallel to each other and a plurality of second electrodes extending in a second direction perpendicular to the first direction are provided in parallel to each other; and a three-electrode type PDP in which a plurality of first electrodes and a plurality of second electrodes each extending in a first direction are alternately provided in parallel to each other and a plurality of third electrodes extending in a second direction perpendicular to the first direction are provided in parallel to each other. Recently, the three-electrode type PDP has become widely used.

In a general structure of the three-electrode type PDP, first (X) electrodes and second (Y) electrodes are provided by turns in parallel to each other on a first substrate, third (address) electrodes extending in the direction perpendicular to the first and second electrodes are provided on a second substrate in opposition to the first substrate, and each surface of the electrodes is covered with a dielectric layer. On the second substrate, one-directional stripe-shaped ribs extending in parallel to the third electrode are further provided between the third electrodes, or two-dimensional grid-shaped ribs arranged in parallel to the third electrodes and the first and second electrodes are provided so that the cells are separated from one another and, after phosphor layers are formed between the ribs, the first and second substrates are bonded together to each other. Therefore, there may be a case where the dielectric layers and the phosphor layers and, further, the ribs, are formed on the third electrode.

After the charges (wall charges) in the vicinity of the electrode in all of the cells are brought into a uniform state by applying a voltage between the first and second electrodes and addressing is performed to selectively leave the wall charges in a cell to be lit by applying a scan pulse sequentially to the second electrode and applying an address pulse to the third electrode in synchronization with the scan pulse, a sustain discharge is caused to occur in the cell to be lit in which the wall charges are left by the addressing by applying a sustain discharge pulse that makes the neighboring electrodes between which a discharge is caused to occur have opposite polarities alternately. The phosphor layer emits light, which is seen through the first substrate, due to the ultraviolet rays generated by the discharge. Because of this, the first and second electrodes are composed of an opaque bus electrode made of metal material and a transparent electrode such as an ITO film, and light generated in the phosphor layer can be seen through the transparent electrode. As the structure and operations of a general PDP are widely known, a detailed explanation will not be given here.

Concerning the three-electrode type PDP as described above, various PDPs in which a fourth electrode is provided between the first electrode and the second electrode in parallel thereto have been proposed.

For example, Japanese Unexamined Patent Publication (Kokai) No. 6-260092 has described a PDP device of non-address/display separation (non-ADS) system using a PDP in which a fourth electrode is provided between the first electrode and the second electrode in parallel thereto.

Japanese Unexamined Patent Publication (Kokai) No. 2000-123741 has described a PDP device that produces an interlaced display by using display lines between the first electrode and the fourth electrode and between the second electrode and the fourth electrode.

Japanese Unexamined Patent Publication (Kokai) No. 2002-110047 has described various PDPs in which the fourth electrode is provided between the first electrode and the second electrode in parallel thereto and a configuration in which the fourth electrode is used for various purposes.

Japanese Unexamined Patent Publication (Kokai) No. 2001-34228 and Japanese Unexamined Patent Publication (Kokai) No. 2004-192875 have described a configuration in which the fourth electrode is provided between the first electrode and the second electrode between which no discharge is caused to occur (non-display line) and the fourth electrode is used for a trigger operation, discharge prevention in a non-display line (reverse slit prevention), and a reset operation.

When a discharge gas is enclosed in a discharge space and a discharge is caused to occur between two electrodes, for example, in a PDP, it is known that the threshold voltage of discharge (the discharge start voltage) is determined based on the product of the distance between two electrodes and the pressure of the discharge gas. Japanese Unexamined Patent Publication (Kokai) No. 2004-71219 has described a configuration in which a uniform discharge is caused to occur by making the distance between electrodes between which a sustain discharge is caused to occur differ from portion to portion.

### SUMMARY OF THE INVENTION

A PDP device is required to improve a light-emission efficiency and to be capable of obtaining a high display luminance with a low power consumption. If the distance (slit width) between electrodes between which a discharge is caused to occur is increased and a long-distance discharge is caused to occur, light emission efficiency is improved, however, the discharge start voltage is raised, therefore, it is necessary to raise a voltage to be applied, resulting in various problems such the cost of the drive circuit being increased.

The object of the present invention is to realize a plasma display panel, the light emission efficiency of which has been improved, without the raising the discharge start voltage.

In order to attain the above-mentioned object, the plasma display panel (PD) according to the present invention is a three-electrode type PDP in which a fourth electrode (Z) is provided at the position at which a main discharge is caused to occur between a first (X) electrode and a second (Y) electrode for causing a main discharge (sustain discharge) to occur for display and at least one of the distance between the first electrode and the fourth electrode and the distance between the second electrode and the fourth electrode changes gradually in a cell.

In other words, the plasma display panel (PDP) according to the present invention is characterized by being a plasma display panel comprising a first substrate and a second substrate arranged so as to be in opposition to the first substrate and forming a discharge space in which a discharge gas has been sealed between the first substrate and itself, the first substrate comprising a plurality of first bus electrodes and a plurality of second bus electrodes provided alternately, first discharge electrodes each provided so as to be connected to each of the first bus electrodes, and second discharge electrodes each provided so as to be connected to each of the second bus electrodes, and the second substrate comprising a plurality of third electrodes provided so as to intersect the first and second bus electrodes, wherein a main discharge for display is caused to occur between the first discharge electrode and the second discharge electrode, a plurality of fourth electrodes are provided at the position at which the main discharge is caused to occur between the first discharge electrode and the second discharge electrode, the first discharge electrode and the second discharge electrode are in opposition to the edge of each of the fourth electrodes when viewed in the direction perpendicular to the first and second substrates, and at least one of the distance between the fourth electrode and the first discharge electrode in opposition to each other and the distance between the fourth electrode and the second discharge electrode in opposition to each other changes gradually in a cell.

When a discharge gas is sealed in a discharge space and a discharge is caused to occur between two electrodes, for example, in a PDP, it is known that the threshold voltage of discharge (the discharge start voltage) is determined based on the product of the distance between two electrodes and the pressure of the discharge gas, and a curve plotted as a graph to represent the change, where the horizontal axis denotes the product and the vertical axis denotes the discharge start voltage, is called the Paschen curve. The Paschen curve reaches the minimum value when the product of the distance between two electrodes and the pressure of the discharge gas assumes a certain value and such a state is called the Paschen minimum. According to the distance between the first electrode and the second electrode and the pressure of the discharge gas in a current PDP, the product is by far larger than the Paschen minimum and the nearer the value is to the Paschen minimum, the higher the light emission efficiency is.

In the PDP according to the present invention, the fourth electrode is provided between the first bus electrode and the second bus electrode and the distance between the fourth electrode and the first bus electrode or the distance between the fourth electrode and the second bus electrode is smaller than the distance between the first bus electrode and the second bus electrode. Therefore, a discharge between the fourth electrode and the first bus electrode or between the fourth electrode and the second bus electrode is more likely to occur than a discharge between the first bus electrode and the second bus electrode because the discharge start voltage is lower. Once a discharge is caused to occur, a discharge is easily caused to occur also across the longer distance between the first bus electrode and the second bus electrode and, therefore, discharges are caused to occur at high light emission efficiency. In the PDP according to the present invention, as the distance between the fourth electrode and the first bus electrode or between the fourth electrode and the second bus electrode gradually changes, the discharge start voltage becomes a lower voltage near to the Paschen minimum even the distance between the fourth electrode and the first bus electrode or between the fourth electrode and the second bus electrode varies, and after a discharge is caused to occur at a low voltage between the fourth electrode and the first bus electrode or between the fourth electrode and the second bus electrode, a discharge is caused to occur continuously across longer distances and, thus, the light emission efficiency can be improved.

It is preferable for the main discharge for display to be caused to occur between the first discharge electrode and the second discharge electrode because light emission efficiency is higher and for the area of the fourth electrode to be as small as possible because the discharge between the fourth electrode and the first or second electrode or between the fourth electrode and the second electrode is used as a trigger.

The fourth electrode is formed by the fourth bus electrode and the fourth discharge electrode as the first and second electrodes or formed only by the fourth bus electrode. Either way, it has a bus electrode that shuts off light and is arranged at the portion of a display cell, therefore, also from the standpoint of these, it is preferable for the area of the fourth electrode to be as small as possible. It is possible to make the transparent fourth discharge electrode wider than the fourth bus electrode, however, also in this case, it is preferable not to increase the area of the fourth discharge electrode too much.

In order to reduce the area of the fourth electrode as much as possible, it is necessary for the fourth discharge electrode and the fourth bus electrode substantially overlap. It is preferable for the fourth bus electrode to be rectilinear and to extend substantially in parallel to the first and second bus electrodes.

In order to make one of the distance between the fourth electrode and the first discharge electrode and the distance between the fourth electrode and the second discharge electrode differ from portion to portion, it is preferable to make the distance between the fourth electrode and the second (Y) discharge electrode differ from portion to portion. Due to this, when the same voltage as that applied to the first (X) discharge electrode is applied to the fourth electrode, the fourth electrode serves as a trigger electrode for the second (Y) discharge electrode. In this case, the same voltage is applied to the first (X) discharge electrode as a common electrode, therefore, the same voltage is applied also to the fourth electrode, as a result, it is possible to simplify the configuration of the drive circuit of the fourth electrode.

As for the shape of the edge of the first or second electrode in opposition to the fourth electrode, various modification examples are possible. For example, linear edges extending in different directions, different curved edges, and a stepwise shape in which the distance changes stepwise may be possible. If a distance that satisfies the Paschen minimum condition is made to exist in the range in which the distance changes continuously, it is possible to obtain the minimum discharge start voltage.

When both the first discharge electrode and the second discharge electrode have edges in opposition to and extending rectilinearly in the direction different from that of the linear edge of each of the fourth electrodes, if the edges of the first discharge electrode and the second discharge electrode in opposition to each other with the fourth electrode being sandwiched in between are made to extend in different directions, a transition takes place smoothly to a discharge at the portion at which the first discharge electrode and the second discharge electrode are close to each other with a discharge between the fourth electrode and the first or between the fourth electrode and the second electrode as a trigger, and further, a transition takes place smoothly to a long-distance discharge at the portion at which the first discharge electrode and the second discharge electrode are apart, that is, a transition takes place smoothly to a discharge with high light emission efficiency. In contrast to this, it is also possible to make parallel to each other the edges of the first discharge electrode and the second discharge electrode in opposition to each other with the fourth electrode being sandwiched in between, and in this case, a transition takes place somewhat less smoothly to a discharge between the first discharge electrode and the second discharge electrode with a discharge between the fourth electrode and the first electrode or between the fourth electrode and the second electrode as a trigger, compared to the case described above, however, as the distance between the first discharge electrode and the second discharge electrode in a cell is constant, it is possible to cause a discharge to occur evenly in the cell.

The fourth electrode is formed in the same layer in which the first and second bus electrodes and the first and the second discharge electrodes are formed. In this case, as it is possible to form the fourth electrode at the same time as the formation of the first and second bus electrodes and the first and second discharge electrodes, the number of processes is not increased. It is necessary to set the minimum distance between the fourth electrode and the first bus electrode and between the fourth electrode and the second bus electrode to a distance that does not cause a short circuit taking into the consideration the manufacture errors, therefor, it cannot be too small. Therefore, it is difficult to set the minimum distance between the fourth electrode and the first bus electrode and between the fourth electrode and the second bus electrode to the Paschen minimum under current conditions.

It is also possible to form the fourth electrode on the dielectric layer provided on the first and second bus electrodes and the first and second discharge electrodes. In this case, the process for forming the fourth electrode and the dielectric layer thereon is added. In this case, as the fourth electrode and the first and second bus electrodes are formed in different layers, a short circuit does not occur and, therefore, it is possible to set the minimum distance between the fourth electrode and the first bus electrode and between the fourth electrode and the second bus electrode to a very small one and it is also possible to realize the Paschen minimum condition.

It is possible to apply the configuration of the present invention to a normal three-electrode type PDP in which a discharge is caused to occur between a pair of first electrode and second electrode or to a so-called ALIS system PDP as described in Japanese Patent No. 2801893. When the present invention is applied to a normal three-electrode type PDP, the fourth electrode is arranged between a pair of first bus electrode and second bus electrode to which the first discharge electrode and the second discharge electrode between which a discharge is caused to occur are connected, and a common voltage is applied. When the present invention is applied to an ALIS system PDP, the fourth electrodes are arranged in all of the portions between the first bus electrode and the second bus electrode and are divided into four groups depending on the portions at which they are arranged and a common voltage is applied to each group.

According to the present invention, it is possible to reduce the discharge start voltage of a sustain discharge while maintaining high light emission efficiency. Due to this, it is possible to realize a plasma display panel capable of obtaining high display luminance with a low power consumption. Further, when a plasma display device is manufactured using such a plasma display panel, the sustain discharge voltage can be reduced, therefore, a drive circuit can be configured of parts having a low breakdown voltage and as a result, the cost can be reduced.

### BRIEF DESCRIPTION OF THE DRAWINGS

The features and advantages of the invention will be more clearly understood from the following description taken in conjunction with the accompanying drawings in which:

FIG. 1 is a diagram showing a general configuration of a PDP device in a first embodiment of the present invention.

FIG. 2 is an exploded perspective view of the PDP in the first embodiment.

FIG. 3A and FIG. 3B are sectional views of the PDP in the first embodiment.

FIG. 4 is a diagram showing electrode shapes in the first embodiment.

FIG. 5 is a diagram showing drive waveforms in the first embodiment.

FIG. 6A to FIG. 6G are diagrams showing the change of wall charges in the first embodiment.

FIG. 7 is a diagram showing a modification example of an electrode structure.

FIG. 8 is a diagram showing a modification example of electrode shapes.

FIG. 9 is a diagram showing a modification example of electrode shapes.

FIG. 10 is a diagram showing a modification example of electrode shapes.

FIG. 11 is a diagram showing electrode shapes in a second embodiment of the present invention.

FIG. 12 is a diagram showing drive waveforms in the second embodiment.

FIG. 13A to FIG. 13G are diagrams showing the change of wall charges in the second embodiment.

FIG. 14 is a diagram showing a general configuration of a PDP device in a third embodiment of the present invention.

FIG. 15 is a diagram showing electrode shapes in the third embodiment.

FIG. 16 is a diagram showing drive waveforms (odd-numbered field) in the third embodiment.

FIG. 17 is a diagram showing drive waveforms (even-numbered field) in the third embodiment.

### DESCRIPTION OF THE PREFERRED EMBODIMENTS

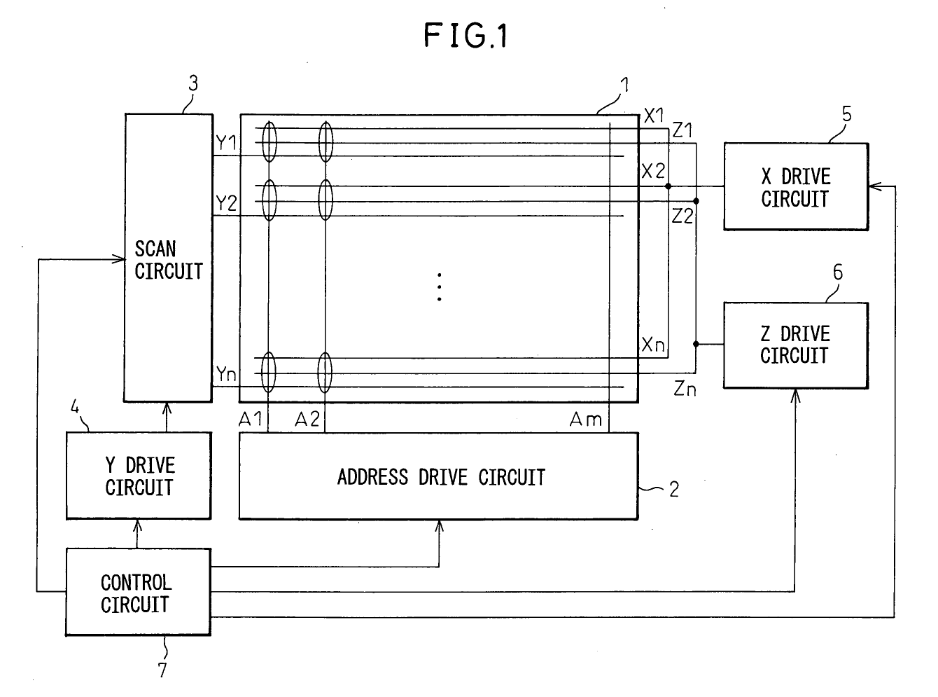

FIG. 1 is a diagram showing a general configuration of a plasma display device (PDP device) in a first embodiment of the present invention. A PDP 1 used in the PDP device in the first embodiment is a conventional PDP, in which a discharge is caused to occur between a pair of first (X) electrode and second (Y) electrode and to which the present invention is applied. As shown in FIG. 1, in the PDP 1 in the first embodiment, X electrodes X1, X2, . . . , Xn and Y electrodes Y1, Y2, . . . , Yn both extending in the transverse direction are arranged by turns and each of fourth electrodes Z1, Z2, . . . , Zn is arranged between each pair of X electrode and Y electrode. Therefore, n sets of the three electrodes, that is, the X electrode, the Y electrode, and the Z electrode, are formed. Further, address electrodes A1, A2, . . . , Am extending in the vertical direction are arranged so as to intersect the n sets of the X electrode, the Y electrode, and the Z electrode and a cell is formed at the intersection. Therefore, n display rows and m display columns are formed.

As shown in FIG. 1, the PDP device in the first embodiment comprises an address drive circuit 2 for driving the m address electrodes, a scan circuit 3 for applying a scan pulse to the n Y electrodes, a Y drive circuit 4 for commonly applying a voltage other than a scan pulse to the n Y electrodes via the scan circuit 3, an X drive circuit 5 for commonly applying a voltage to the n X electrodes, a Z drive circuit for commonly applying a voltage to the n Z electrodes, and a control circuit 7 for controlling each component. The PDP device in the first embodiment differs from a conventional one in that the PDP 1 is provided with the Z electrodes and the Z drive circuit 6 for driving them, and other components are the same as those in the conventional one, therefore, only the components relating to the Z electrode are explained here and an explanation about other components will not be given here.

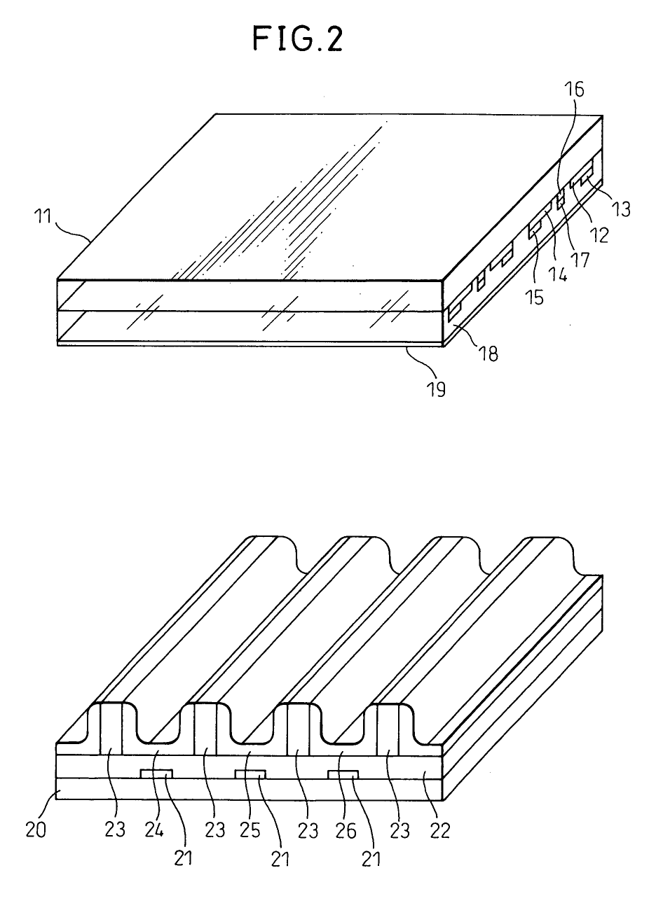

FIG. 2 is an exploded perspective view of the PDP in the first embodiment. As shown schematically, on a front (first) glass substrate 11, first (X) bus electrodes 13 and second (Y) bus electrodes 15 both extending in the transverse direction are arranged by turns in parallel to each other, making up pairs. X and Y light-transmitting electrodes (discharge electrodes) 12 and 14 are provided so as to overlap the X and Y bus electrodes 13 and 15 and parts of the X and Y discharge electrodes 12 and 15 are extending toward the electrodes in opposition thereto. Between a pair of X and Y bus electrodes 13 and 15, a fourth discharge electrode 16 and a fourth bus electrode 17 are provided so as to overlap each other. For example, the bus electrodes 13, 15, and 17 are formed by a metal layer and the discharge electrodes 12, 14, and 16 are formed by, for example, an ITO layer film, and the resistances of the bus electrodes 13, 15, and 17 are smaller than or equal to the resistances of the discharge electrodes 12, 14, and 16. Hereinafter, the parts of the X and Y discharge electrodes 12 and 14 extending from the X and Y bus electrodes 13 and 15 are simply referred as X and Y discharge electrodes 12 and 14 and the fourth discharge electrode 16 and the fourth bus electrode 17 together are referred to as the fourth electrode.

On the discharge electrodes 12, 14, and 16 and the bus electrodes 13, 15, and 17, a dielectric layer 18 is formed so as to cover these electrodes. The dielectric layer 18 is composed of SiO₂ etc. through which visible light is transmited, and further, a protective layer 19 such as MgO is formed thereon. The protective layer 19 causes a discharge to grow by emitting electrons by ion bombardment and has an effect of a reduction in discharge voltage, discharge delay, etc. In this structure, as all of the electrodes are covered with the protective layer 19, it becomes possible to cause a discharge to occur using the effect of the protective layer even if any electrode group becomes a cathode. The glass substrate 11 having the above-mentioned configuration is used as a front substrate and a display is seen through the glass substrate 11.

On the other hand, on a back (second) substrate 20, third (address) electrodes 21 are provided so as to intersect the bus electrodes 13, 15, and 17. For example, the address electrode 21 is formed by a metal layer. On the address electrode group, a dielectric layer 22 is formed. Further, longitudinal direction ribs 23 are formed thereon. On the side face and the bottom face of a groove formed by the rib 23 and the dielectric layer 22, phosphor layers 24, 25, and 26 that generate red, green, and blue visible light by being excited by ultraviolet rays generated by a discharge.

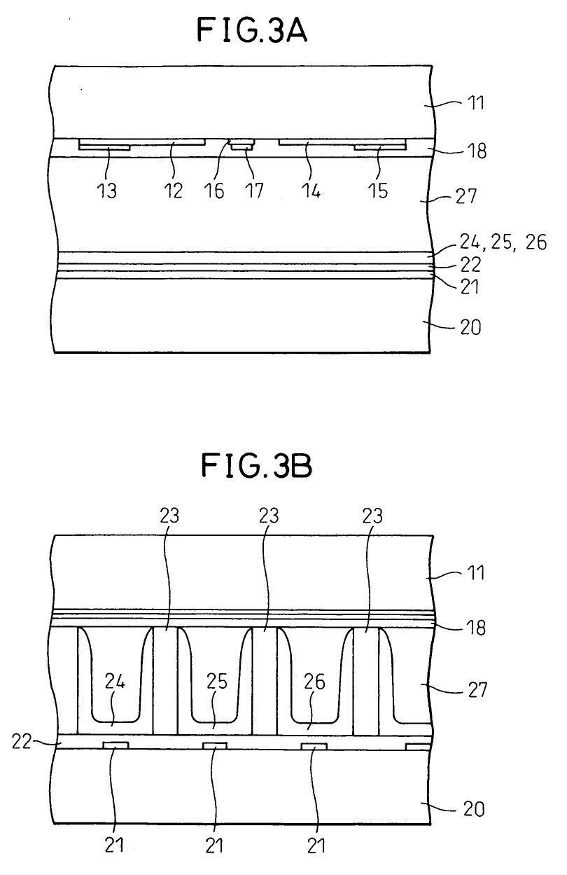

FIG. 3A and FIG. 3B are partial sectional views of the PDP in the first embodiment, wherein FIG. 3A is a longitudinal sectional view and FIG. 3B is a transverse sectional view. Into a discharge space 27 between the front substrate 11 and the back substrate 20 separated by the ribs 23, a discharge gas such as Ne, Xe, He, etc., is sealed.

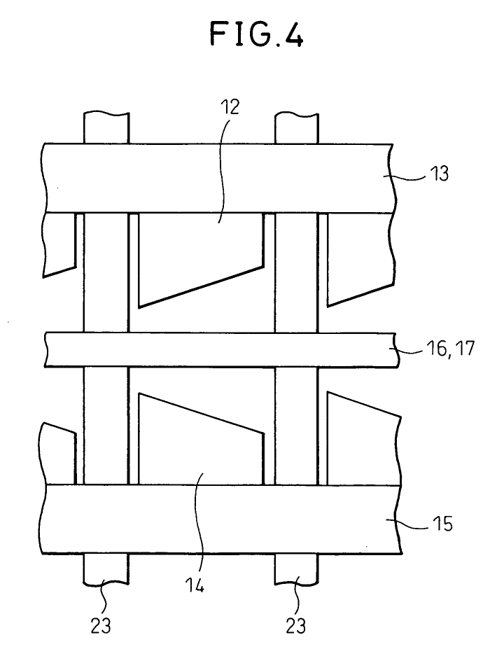

FIG. 4 is a diagram showing electrode shapes in a cell. As shown schematically, the X bus electrode 13 and the Y bus electrode 15 are arranged in parallel to each other and the Z electrodes 16 and 17 are arranged in parallel to each other at the center thereof. Then, the ribs 23 extending in the direction perpendicular to the bus electrodes 13, 15, and 17 are arranged. The address electrode is arranged between the ribs 23, however, it is not shown schematically. At each portion defined by the ribs 23, the X discharge electrode 12 extending from the X bus electrode 13 and the Y discharge electrode 14 extending from the Y bus electrode 15 are provided. The edges of the X discharge electrode 12 and the Y discharge electrode in opposition to the Z electrodes 16 and 17 are straight lines inclined with respect to the direction in which the bus electrodes 13, 15, and 17 extend. Due to this, the distances between the edges of the X discharge electrode 12 and the Y discharge electrode 14 and the edges of the Z electrodes 16 and 17 in opposition thereto, that is, the slit widths, change continuously. Further, the distances between edges of the X electrode 12 and the Y discharge electrode 14 in opposition to each other with Z electrodes 16 and 17 being sandwiched in between also change continuously. In the first embodiment, the smaller distance between the X discharge electrode 12 and the Z electrodes 16 and 17 and the smaller distance between the Y discharge electrode 14 and the Z electrodes 16 and 17 are closer to the Paschen minimum, therefore, the discharge start voltage can be reduced.

Further, when a discharge spreads to a discharge between the X discharge electrode 12 and the Y discharge electrode 14 with a discharge between the Z electrodes 16 and 17 and the X discharge electrode 12 or between the Z electrodes 16 and 17 and the Y discharge electrode 14 as a trigger, the distance between the X discharge electrode 12 and the Y discharge electrode 14 increases gradually, therefore, it is possible for a transition of a discharge to take place smoothly from a discharge across a smaller distance to a long-distance discharge across a larger distance.

Next, the operation of the PDP device in the first embodiment is explained below. It is possible for each cell of the PDP to select only a lit state or an unlit state and it is not possible to change luminance, that is, to produce a graded display. Therefore, one frame is divided into a plurality of subfields with a predetermined weight and a graded display is produced by combining subfields to be lit for each cell. Normally, each subfield has the same drive sequence.

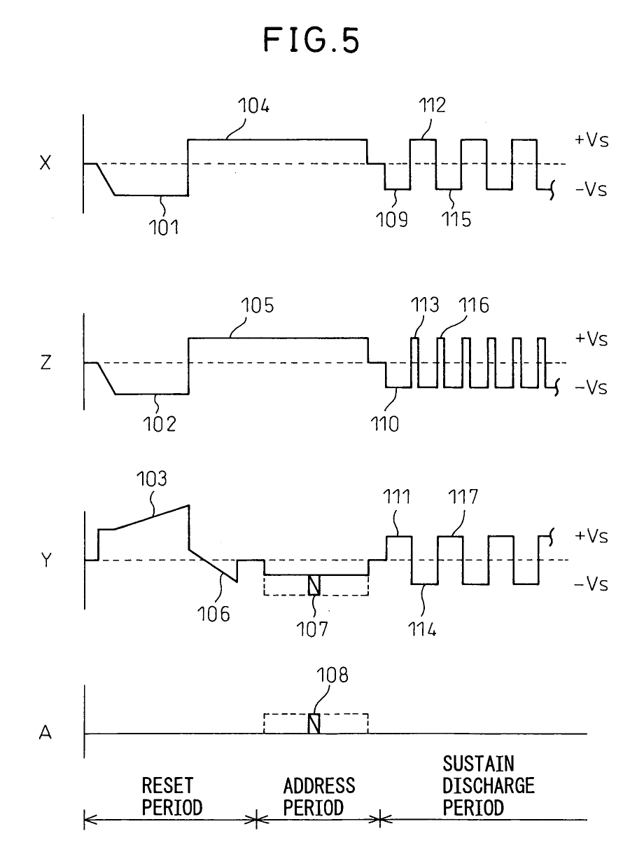

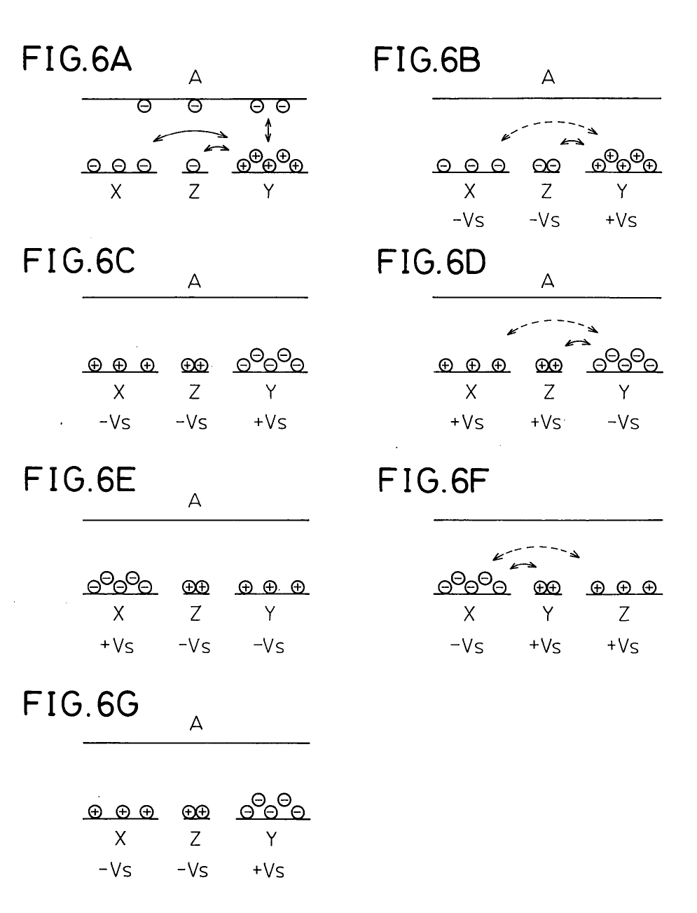

FIG. 5 is a diagram showing drive waveforms in a subfield of the PDP device of the first embodiment, and FIG. 6A to FIG. 6G are diagrams showing the change in wall charges in the first embodiment.

At the beginning of the reset period, in a state in which 0 V is applied to the address electrode A, negative reset pulses 101 and 102 the voltage of which gradually drops and then reaches a constant voltage are applied to the X electrode and the Z electrode and after a predetermined voltage is applied, a positive reset pulse 103 the voltage of which gradually increases is applied to the Y electrode. Due to this, a discharge is first caused to occur between the Z electrodes 16 and 17 and the Y discharge electrode 14 in all of the cells and a transition takes place to a discharge between the X discharge electrode 12 and the Y discharge electrode 14. What is applied here is an obtuse wave the voltage of which changes gradually and, therefore, a slight discharge is caused to occur and charges are formed repeatedly, and thus wall charges are formed uniformly in all of the cells. The polarity of the formed wall changes is positive in the vicinity of the X discharge electrode and the Z electrode and negative in the vicinity of the Y discharge electrode.

Next, by applying positive compensation voltages 104 and 105 (for example, +Vs) to the X discharge electrode and the Z electrode and a compensation obtuse wave 106 the voltage of which drops gradually to the Y electrode, the voltage having the polarity opposite to that of the formed wall charges described above is applied in the form of an obtuse wave and, therefore, the number of wall charges in the cell is reduced by a slight discharge. As described above, the reset period is completed and all of the cells are put into a uniform state.

In the PDP of the present embodiment, the distance between the Z electrodes 16 and 17 and the Y discharge electrode 14 is small and a discharge is caused to occur even at a low discharge start voltage and with this discharge as a trigger, a transition takes place to a discharge between the X discharge electrode 12 and the Y discharge electrode 14 and, therefore, it is possible to reduce a reset voltage to be applied between the X electrode and the Y electrode and between the Z electrode and the Y electrode during the reset period. Due to this, it is possible to increase contrast by reducing the amount of emitted light by a reset discharge that does not relate to a display.

During the next address period, the same voltage as the compensation voltages 104 and 105 (for example, +Vs) are applied to the X electrode and the Z electrode and further, a scan pulse 107 is applied sequentially in a state in which a predetermined negative voltage is applied to the Y electrode. In accordance with the application of the scan pulse 107, an address pulse 108 is applied to the address electrode of a cell to be lit. Due to this, as shown in FIG. 6A, a discharge is caused to occur between the Y electrode to which the scan pulse has been applied and the address electrode to which the address pulse has been applied and with this discharge as a trigger, a discharge is caused to occur between the X electrode and the Y electrode and between the Z electrode and the Y electrode. By this address discharge, negative wall charges are formed in the vicinity of the X electrode and the X electrode (on the surface of the dielectric layer) and positive wall charges are formed in the vicinity of the Y electrode, as shown in FIG. 6B. As the area of the Z electrode is smaller than that of the X electrode, the number of wall charges formed in the vicinity of the Z electrode is smaller than the number of wall charges formed in the vicinity of the X electrode. Further, at the Y electrode, positive wall charges are formed, the number of which corresponding to the sum of the negative wall charges formed in the vicinity of the X electrode and the Y electrode. As no address discharge is caused to occur in a cell to which neither scan pulse nor address pulse is applied, therefore, the number of wall charges at the time of reset is maintained. During the address period, the above-mentioned operation is carried out by applying the scan pulse sequentially to all of the Y electrodes and an address discharge is caused to occur in all of the cells to be lit on the entire surface of the panel.

There may be a case where a pulse for adjusting the wall charges formed during the reset period in a cell in which no address discharge has been caused to occur at the end of the address period,

During the sustain discharge period, first negative sustain discharge pulses 109 and 110 having a voltage −Vs are applied to the X electrode and the Z electrode and a positive sustain discharge pulse 111 having a voltage +Vs is applied to the Y electrode. As shown in FIG. 6B, in a cell in which an address discharge has been caused to occur, the voltage due to the positive wall charges formed in the vicinity of the Y electrode is added to the voltage +Vs and the voltage due to the negative wall charges formed in the vicinity of the X electrode and the Z electrode is added to the voltage −Vs. Due to this, a discharge is caused to occur first across the small distance between the Z electrode and the Y electrode and with this discharge as a trigger, a transition takes place to a discharge across the large distance between the X electrode and the Y electrode. The discharge between the X electrode and the Y electrode is a long-distance discharge and it has an excellent light emission efficiency. This discharge comes to an end when positive charges among charges generated by the discharge are accumulated as wall charges in the vicinity of the X electrode and the Z electrode, negative charges are accumulated as wall charges in the vicinity of the Y electrode, and the voltage due to the wall charges reduces the voltages between the X electrode and the Y electrode and between the Z electrode and the Y electrode. At the end of the discharge, as shown in FIG. 6C, positive wall charges are formed in the vicinity of the X electrode and the Y electrode and negative wall charges are formed in the vicinity of the Y electrode. In a cell in which no address discharge has been caused to occur, the above-mentioned discharge is not caused to occur and no discharge is caused to occur during the sustain discharge period, therefore, an explanation will not be given here.

Next, as shown in FIG. 5, a positive sustain discharge pulse 112 having the voltage +Vs is applied to the X electrode, a negative sustain discharge pulse 114 having the voltage −Vs is applied to the Y electrode, and a pulse 113 the voltage of which changes to the voltage −Vs shortly after changing to the voltage +Vs is applied to the Z electrode. Due to this, as shown in FIG. 6D, the voltage due to the negative wall charges formed in the vicinity of the Y electrode is added to the voltage −Vs and the voltage due to the positive wall charges formed in the vicinity of the X electrode and the Z electrode is added to the voltage +Vs. Due to this, a discharge is first caused to start between the Z electrode and the Y electrode and with this discharge as a trigger, a transition takes place to a discharge across the large distance between the X electrode and the Y electrode. Immediately after this, the voltage applied to the Z electrode changes from +Vs to −Vs and the discharge between the Z electrode and the Y electrode comes to an end. The discharge between the X electrode and the Y electrode comes to an end when negative charges are accumulated as wall charges in the vicinity of the X electrode and positive charges are accumulated as wall charges in the vicinity of the Y electrode, however, as a −Vs voltage is applied to the Z electrode at this time, positive wall charges are formed in the vicinity of the Z electrode. Therefore, when the discharge comes to an end, as shown in FIG. 6E, negative wall charges are formed in the vicinity of the X electrode and positive wall charges are formed in the vicinity of the Y electrode and the Z electrode.

Next, as shown in FIG. 5, a negative sustain discharge pulse 115 having the voltage −Vs is applied to the X electrode, a positive sustain discharge pulse 117 having the voltage +Vs is applied to the Y electrode, and a pulse 116 the voltage of which changes to the voltage −Vs shortly after changing to the voltage +Vs is applied to the Z electrode. Due to this, as shown in FIG. 6F, the voltage due to the negative wall charges formed in the vicinity of the X electrode is added to the voltage −Vs and the voltage due to the positive wall charges formed in the vicinity of the Y electrode and the Z electrode is added to the voltage +Vs. Due to this, a discharge is first caused to start between the Z electrode and the X electrode and with this discharge as a trigger, a transition takes place to a discharge across the large distance between the X electrode and the Y electrode. Immediately after this, the voltage applied to the Z electrode changes from +Vs to −Vs and the discharge between the Z electrode and the X electrode comes to an end, however, as −Vs is applied to the Z electrode at this time, positive wall charges are formed in the vicinity of the Z electrode. Therefore, when the discharge comes to an end, as shown in FIG. 6G, positive wall charges are formed in the vicinity of the X electrode and the Z electrode and negative wall charges are formed in the vicinity of the Y electrode. In other words, it can be said that the state returns to that shown in FIG. 6C. After this, by applying positive and negative sustain discharge pulses alternately to the X electrode and the Y electrode and a pulse with a narrow width to the Z electrode in synchronization with the application of the sustain discharge pulse, the operation from FIG. 6C to FIG. 6G is repeated and thus the sustain discharge is repeated.

Although the first embodiment of the present invention is described as above, there may be various modification examples of the electrode structure and shape Some of modification examples are explained below.

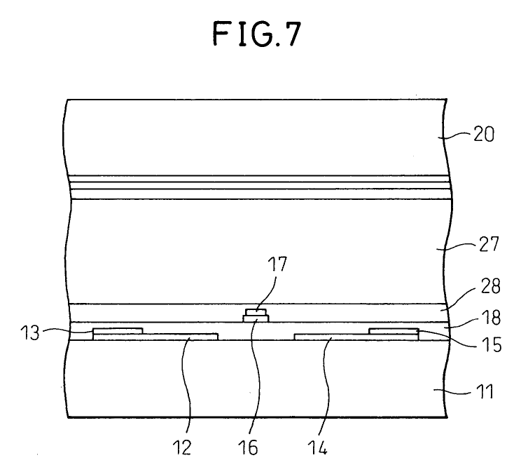

FIG. 7 is a diagram showing a modification example of an electrode structure. In the first embodiment, as shown in FIG. 3A, the Z electrodes (the Z discharge electrode 16, the Z bus electrode 17) are formed in the same layer in which the X electrodes (the X discharge electrode 12, the X bus electrode 13) and the Y electrodes (the Y discharge electrode 14, the Y bus electrode 15) are formed. In this configuration, it is possible to form the Z electrode in the same process as that for the X the electrode and the Y electrode and it is not necessary to employ a new process for providing the Z electrode. However, there arises a problem that, as the Z electrode is provided between the X discharge electrode 12 and the Y discharge electrode 14, the Z electrode makes a short circuit with the X discharge electrode 12 and the Y discharge electrode 14 owing to the variations in position and line width in the manufacturing process, and the yield is reduced. Therefore, in the modification example in FIG. 7, the Z electrodes (the Z discharge electrode 16, the Z bus electrode 17) are formed on the dielectric layer 18 covering the X electrodes (the X discharge electrode 12, the X bus electrode 13) and the Y electrodes (the Y discharge electrode 14, the Y bus electrode 15) and further, a dielectric layer 28 is formed thereon so as to cover them. In this configuration also, the same operation as that in the first embodiment is possible.

The modification example in FIG. 7 has a problem that the manufacturing cost is pushed up because the process for providing the Z electrode is added compared to the first embodiment, however, as the Z electrode is formed in a layer different from that in which the X electrode and the Y electrode are formed, the Z electrode does not make a short circuit with the X discharge electrode 12 and the Y discharge electrode 14 and the yield is not reduced because there is no short circuit. Further, as the Z electrode is provided in a different layer, it is also possible to make very narrow the distances between the Z electrode and the X discharge electrode 12 and between the Z electrode and the Y discharge electrode 14 when seen in the direction perpendicular to the substrate and, for example, narrower than the distance at which the Paschen minimum occurs. For example, in the electrode shape shown in FIG. 4, when the minimum value of the distances between the X discharge electrode 12 and the Z electrode and between the Y discharge electrode 14 and the Z electrode is narrower than the distance at which the Paschen minimum occurs, as the distance gradually changes, there exists without exception a distance at which the Paschen minimum occurs and the discharge start voltage is set under the Paschen minimum condition. Therefore, it is possible to cause a sustain discharge to occur without fail even if the sustain discharge voltage is lowered.

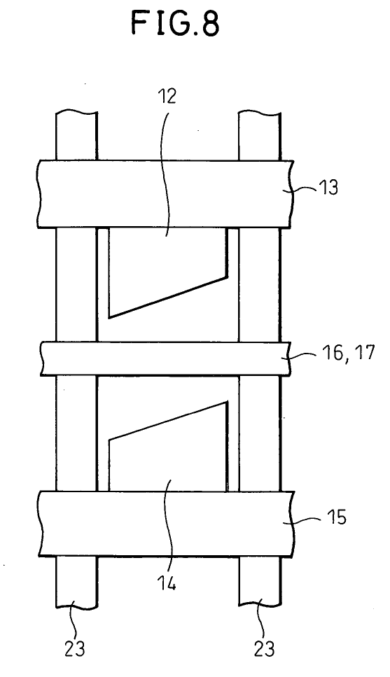

FIG. 8 shows a modification example of an electrode shape. As is obvious from a comparison with FIG. 4, the edges of the X discharge electrode 12 and the Y discharge electrode 14 in opposition to the Z electrodes 16 and 17 are straight lines inclined with respect to the edges of the Z electrodes 16 and 17, however, the edge of the X discharge electrode 12 is parallel to the edge of the Y discharge electrode 14. In other words, the distance between the X discharge electrode 12 and the Y discharge electrode 14 is constant. Due to this, although the transition from a discharge between the Z electrode and the X discharge electrode 12 or between the Z electrode and the Y discharge electrode 14 to a discharge between the X discharge electrode 12 and the Y discharge electrode 14 takes place less smoothly compared to the case of the shape shown in FIG. 4, the proportion of short-distance discharges to the main discharges between the X discharge electrode 12 and the Y discharge electrode 14 is reduced, and long-distance discharges occupy predominantly, light emission efficiency is improved and wall charges are further sufficiently accumulated, therefore, a more stable sustain discharge becomes possible.

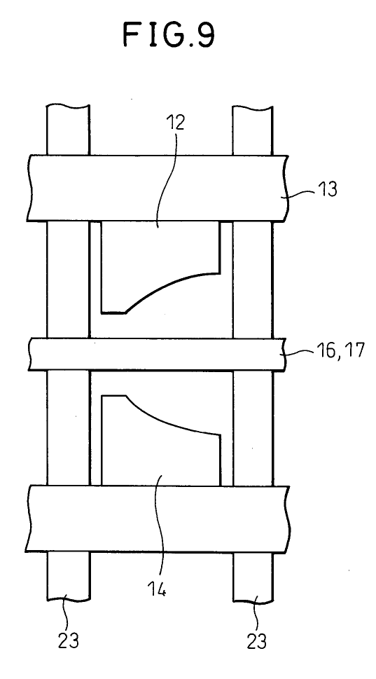

FIG. 9 is a diagram showing another modification example of an electrode shape. As shown schematically, in this modification example, the edges of the X discharge electrode 12 and the Y discharge electrode 14 in opposition to the Z electrodes 16 and 17 are composed of a linear edge that provides a small distance to the Z electrodes 16 and 17 and a curved edge that provides distances changing gradually. In this case also, a transition takes place to a discharge between the X discharge electrode 12 and the Y discharge electrode 14 with a discharge across the small distance between the Z electrodes 16 and 17 and the X discharge electrode 12 or between the Z electrodes 16 and 17 and the Y discharge electrode 14 as a trigger.

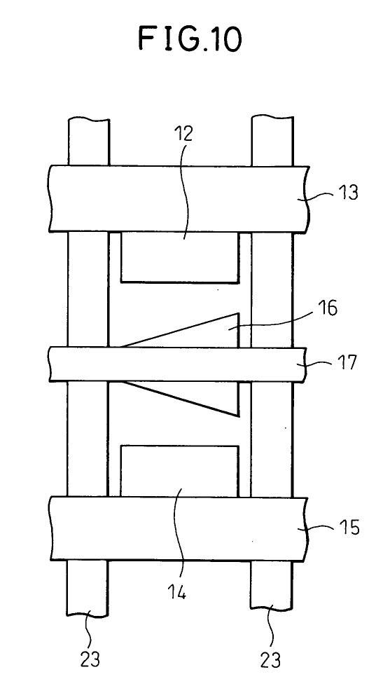

FIG. 10 is a diagram showing another modification example of an electrode shape. As shown schematically, in the modification example, the edges of the X discharge electrode 12 and the Y discharge electrode 14 in opposition to the Z electrode are parallel to the Z bus electrode 17, however, the Z discharge electrode 16 extends in both directions from the Z bus electrode 17 and the edges of the Z discharge electrode 16 are straight lines inclined with respect to the edges of the X discharge electrode 12 and the Y discharge electrode 14. In this shape also, it is possible to carry out the same operation as that in the first embodiment. However, as the area of the Z discharge electrode 16 increases, the proportion of long-distance discharge is reduced and light emission efficiency is reduced, therefore, it is preferable for the area of the Z discharge electrode 16 to be not so large.

The modification examples of an electrode shape are explained as described above, in the modification examples other than that in FIG. 10, the Z bus electrode 17 and the Z discharge electrode 16 have the same shape, it is also possible to provide the Z bus electrode 17 directly on the glass substrate without providing the Z discharge electrode 16.

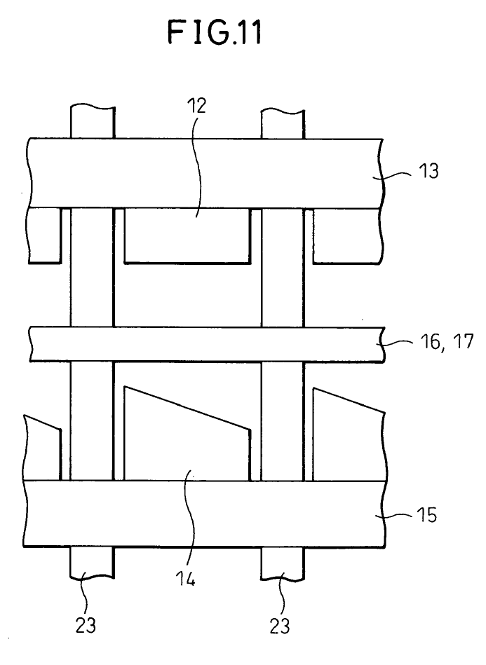

FIG. 11 is a diagram showing an electrode shape in a PDP of a PDP device in a second embodiment of the present invention. As is obvious from a comparison with the electrode shape in the first embodiment shown in FIG. 1, in the electrode shape in the second embodiment, only the edge of the Y discharge electrode 14 is inclined with respect to the edges of the Z electrodes 16 and 17 and the edge of the X discharge electrode 12 is parallel to the edges of the Z electrodes 16 and 17.

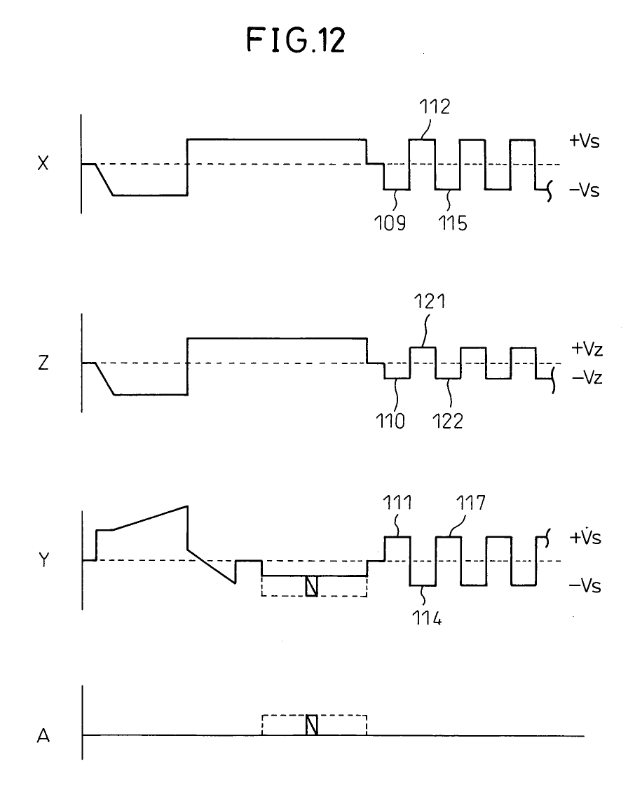

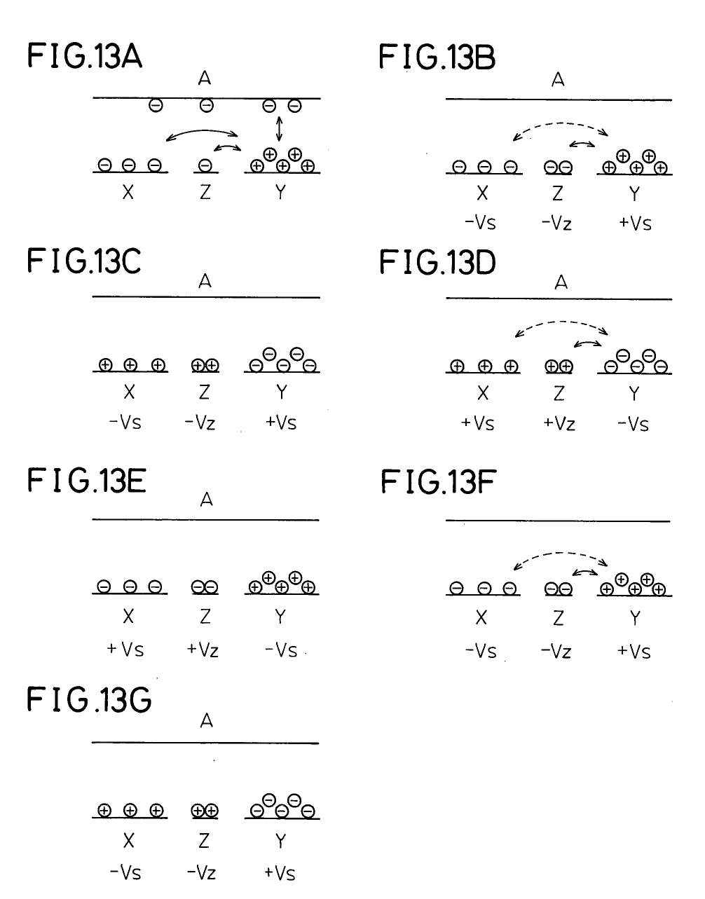

FIG. 12 is a diagram showing drive waveforms in one subfield of the PDP device in the second embodiment and FIG. 13A to FIG. 13G are diagrams showing the change in wall charges in the second embodiment. As is obvious from a comparison with the drive waveforms in the first embodiment in FIG. 5, the second embodiment differs from the first embodiment in that a drive waveform similar to that applied to the X electrode but different in voltage is applied to the Z electrode during the sustain discharge period.

In the same manner as that in the first embodiment, during the sustain discharge period, first the negative sustain discharge pulse 109 having the voltage −Vs is applied to the X electrode, the positive sustain discharge pulse 111 having the voltage +Vs is applied to the Y electrode, and the negative sustain discharge pulse 110 having a voltage −Vz (Vz<Vs) is applied to the Z electrode. As shown in FIG. 13B, the voltage due to the positive wall charges formed in the vicinity of the Y electrode is added to the voltage +Vs, the voltage due to the negative wall charges formed in the vicinity of the X electrode is added to the voltage −Vs, and the voltage due to the negative wall charges formed in the vicinity of the Z electrode is added to the voltage −Vz. As Vz<Vs, the voltage between the Z electrode and the Y discharge electrode is lower than the voltage between the X discharge electrode and the Y discharge electrode, however, the widths of the Z electrode and the Y discharge electrode are narrow, therefore, a slight discharge is first caused to occur between the Z electrode and the Y discharge electrode and with this discharge as a trigger, a transition takes place to a discharge between the X discharge electrode and the Y discharge electrode. Once a discharge between the X discharge electrode and the Y discharge electrode is caused to start, as the voltage between the Z electrode and the Y discharge electrode is lower than the voltage between the X discharge electrode and the Y discharge electrode, a discharge is caused to occur mainly between the X discharge electrode and the Y discharge electrode and a discharge between the Z electrode and the Y discharge electrode remains slight.

When the discharge due to these pulses comes to an end, positive wall charges are formed in the vicinity of the X electrode and the Z electrode and negative wall charges are formed in the vicinity of the Y electrode, as shown in FIG. 13C.

Next, as shown in FIG. 12, the positive sustain discharge pulse 112 having the voltage +Vs is applied to the X electrode, the negative sustain discharge pulse 114 having the voltage −Vs is applied to the Y electrode, and a positive sustain discharge pulse 121 having the voltage +Vz is applied to the Z electrode. As shown in FIG. 13D, the voltage due to the negative wall charges formed in the vicinity of the Y electrode is added to the voltage −Vs, the voltage due to the positive wall charges formed in the vicinity of the X electrode is added to the voltage +Vs, and the voltage due to the positive wall charges formed in the vicinity of the Z electrode is added to the voltage +Vz. Due to this, a slight discharge is first caused to occur between the Z electrode and the Y electrode as described above, and with this discharge as a trigger, a transition takes place to a discharge across the large distance between the X electrode and the Y electrode. In the second embodiment, the voltage applied to the Z electrode is still +Vz, therefore, when the discharge between the X electrode and the Y electrode comes to an end, as +Vz is applied to the Z electrode, negative wall charges are formed in the vicinity of the Z electrode. Therefore, at the end of the discharge, negative wall charges are formed in the vicinity of the X electrode and the Z electrode and positive wall charges are formed in the vicinity of the Y electrode, as shown in FIG. 13E.

Next, as shown in FIG. 12, the negative sustain discharge pulse 115 having the voltage −Vs is applied to the X electrode, the positive sustain discharge pulse 117 having the voltage +Vs is applied to the Y electrode, and a negative pulse 122 having the voltage −Vs is applied to the Z electrode. Due to this, as shown in FIG. 13F, the voltage due to the negative wall charges formed in the vicinity of the X electrode is added to the voltage −Vs, the voltage due to the positive wall charges formed in the vicinity of the Y electrode is added to the voltage +Vs, and the voltage due to the negative wall charges formed in the vicinity of the Z electrode is added to the voltage −Vz. Due to this, a slight discharge is first caused to start between the Z electrode and the Y electrode and with this discharge as a trigger and a transition takes place to a discharge across the large distance between the X electrode and the Y electrode. Similarly, when the discharge between the X electrode and the Y electrode comes to an end, as −Vz is applied to the Z electrode, positive wall charges are formed in the vicinity of the Z electrode as in the vicinity of the X electrode. Therefore, at the end of the discharge, positive wall charges are formed in the vicinity of the X electrode and the Z electrode and negative wall charges are formed in the vicinity of the Y electrode, as shown in FIG. 13G. In other words, it can be said that the state returns to that in FIG. 13C. Hereinafter, by applying positive and negative pulses alternately to the X electrode and the Z electrode, and the Y electrode, the operation from the FIG. 13C to FIG. 13G is repeated and a sustain discharge is repeated.

The general configuration, the electrode structure, etc., in the second embodiment are the same as those in the first embodiment, and above-mentioned modification examples can be applied to the second embodiment similarly.

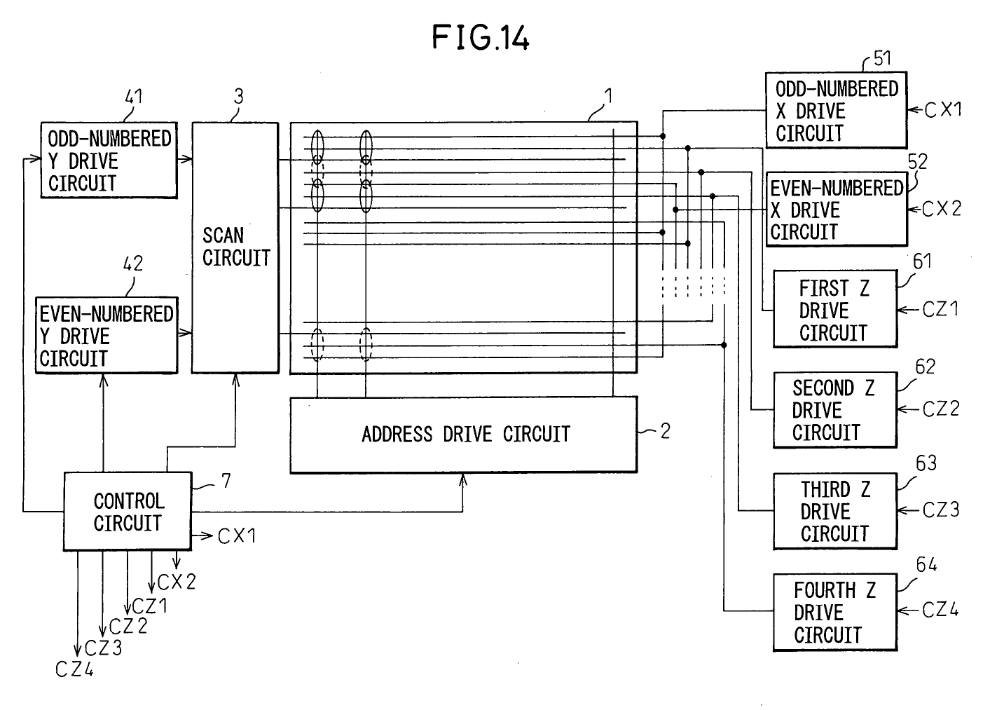

FIG. 14 is a diagram showing a general configuration of a PDP device in a third embodiment of the present invention. The third embodiment is an example in which the present invention is applied to an ALIS system PDP device described in Japanese Patent No. 2801983, in its configuration, first and second electrodes (X and Y electrodes) are provided on a first substrate (a transparent substrate) and third electrodes (address electrodes) are provided on a second substrate (a back substrate), and a fourth electrode (a Z electrode) is provided between the X electrode and the Y electrode. As the ALIS system is described in Japanese Patent No. 2801893, a detailed explanation will not be given here.

As shown in FIG. 14, the plasma display panel 1 has a plurality of first electrodes (X electrodes) and second electrodes (Y electrodes) extending in the transverse direction (lengthwise direction). The plurality of X electrodes and Y electrodes are arranged by turns and the number of X electrodes is greater than that of Y electrodes by one. Between the X electrode and the Y electrode, a fourth electrode (a Z electrode) is arranged. Therefore, the number of Z electrodes is double that of Y electrodes. A third electrode (an address electrode) extends in the direction perpendicular to the X, Y, and Z electrodes. In an ALIS system, all of the portions between the X electrode and the Y electrode are used as display lines and odd-numbered display lines and even-numbered display lines are used to produce an interlaced display. In other words, odd-numbered display lines are formed between an odd-numbered X electrode and an odd-numbered Y electrode and between an even-numbered X electrode and an even-numbered Y electrode, and even-numbered display lines are formed between an odd-numbered Y electrode and an even-numbered X electrode and between an even-numbered Y electrode and an odd-numbered Y electrode. One display field is composed of an odd-numbered field and an even-numbered field, and in the odd-numbered field, odd-numbered display lines are displayed and in the even-numbered field, even-numbered display lines are displayed. Therefore, the respective Z electrodes exist between respective odd-numbered display lines and respective even-numbered display lines. Here, the Z electrodes provided between an odd-numbered X electrode and an odd-numbered Y electrode are referred to as the Z electrodes in a first group, the Z electrodes provided between an odd-numbered Y electrode and an even-numbered X electrode are referred to as the Z electrodes in a second group, the Z electrodes provided between an even-numbered X electrode and an even-numbered Y electrode are referred to as the Z electrodes in a third group, and the Z electrodes provided between an even-numbered Y electrode and an odd-numbered X electrode are referred to as the Z electrodes in a fourth group, respectively. In other words, the (4p+1)-th (p is a natural number) Z electrode is a Z electrode in the first group, the (4p+2)-th Z electrode is a Z electrode in the second group, the (4p+3)-th Z electrode is a Z electrode in the third group, and the (4p+4)-th electrode is a Z electrode in the fourth group.

As shown in FIG. 14, the PDP device in the third embodiment comprises the address drive circuit 2 for driving the address electrode, the scan circuit 3 for applying a scan pulse to the Y electrode, an odd-numbered Y drive circuit 41 for commonly applying a voltage other than the scan pulse to an odd-numbered Y electrode via the scan circuit 3, an even-numbered Y drive circuit 42 for commonly applying a voltage other than the scan pulse to an even-numbered Y electrode via the scan circuit 3, an odd-numbered X drive circuit 51 for commonly applying a voltage to an odd-numbered X electrode, an even-numbered X drive circuit 52 for commonly applying a voltage to an even-numbered X electrode, a first Z drive circuit 61 for commonly driving the Z electrodes in the first group, a second Z drive circuit 62 for commonly driving the Z electrodes in the second group, a third Z drive circuit 63 for commonly driving the Z electrodes in the third group, a fourth Z drive circuit 64 for commonly driving the Z electrodes in the fourth group, and the control circuit 7 for controlling each component.

The PDP in the third embodiment has the same structure as that in the first embodiment except in that the X discharge electrode and the Y discharge electrode are provided on both sides of the X bus electrode and the Y bus electrode, respectively, and that the Z electrode is provided at every portion between the X bus electrode and the Y bus electrode and, therefore, an exploded perspective view is omitted here. It is also possible to form the Z electrode in the same layer in which the X and Y electrodes are formed as shown in FIG. 3 or to form in a layer different from that in which the X and Y electrodes are formed as shown in FIG. 7.

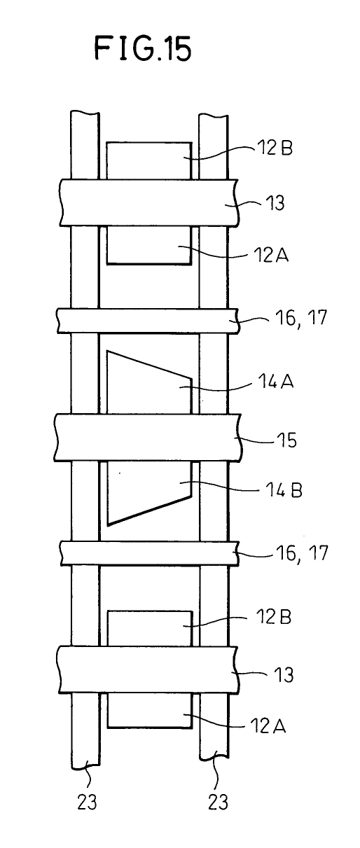

FIG. 15 is a diagram showing electrode shapes in the third embodiment. As shown schematically, the X bus electrodes and the Y bus electrodes 15 are arranged at an equal interval in parallel to each other and the Z electrodes 16 and 17 are arranged at the center thereof in parallel to each other. Then, the ribs 23 extending in the direction perpendicular to the bus electrodes 13, 15, and 17 are arranged. Between the ribs 23, the address electrode is arranged but is not shown. At each portion defined by the ribs 23, an X discharge electrode 12A extending downward from the X bus electrode 13, an X discharge electrode 12B extending upward from the X bus electrode 13, a Y discharge electrode 14A extending upward from the Y bus electrode 15, and a Y discharge electrode 14B extending downward from the Y bus electrode 15 are provided. The edges of the X discharge electrodes 12A and 12B in opposition to the Z electrodes 16 and 17 are parallel to the direction in which the Z electrodes 16 and 17 extend, however, the edges of the Y discharge electrodes 14A and 14B in opposition to the Z electrodes 16 and 17 are straight lines inclined with respect to the direction in which the Z electrodes 16 and 17 extend. In other words, in the third embodiment, as in the second embodiment, the configuration is such one in which the distance between the Y discharge electrode and the Z electrode changes gradually, however, the distance between the X electrode and the Z electrode is constant. Therefore, in the third embodiment, the distance, on the side where the distance between the Y discharge electrodes 14A and 14B and the Z electrodes 16 and 17 is smaller, is nearer to the Paschen minimum and, therefore, the discharge start voltage can be reduced.

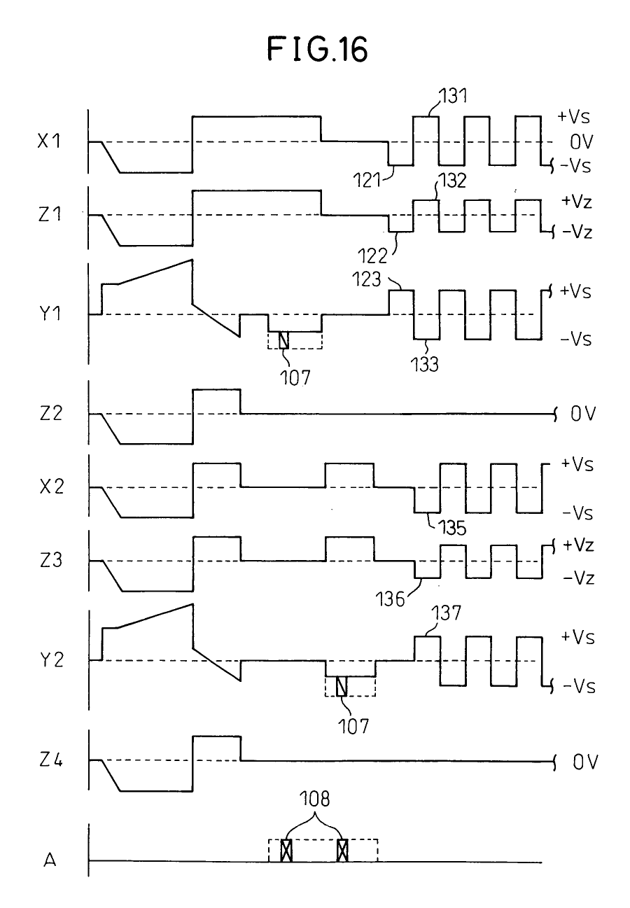

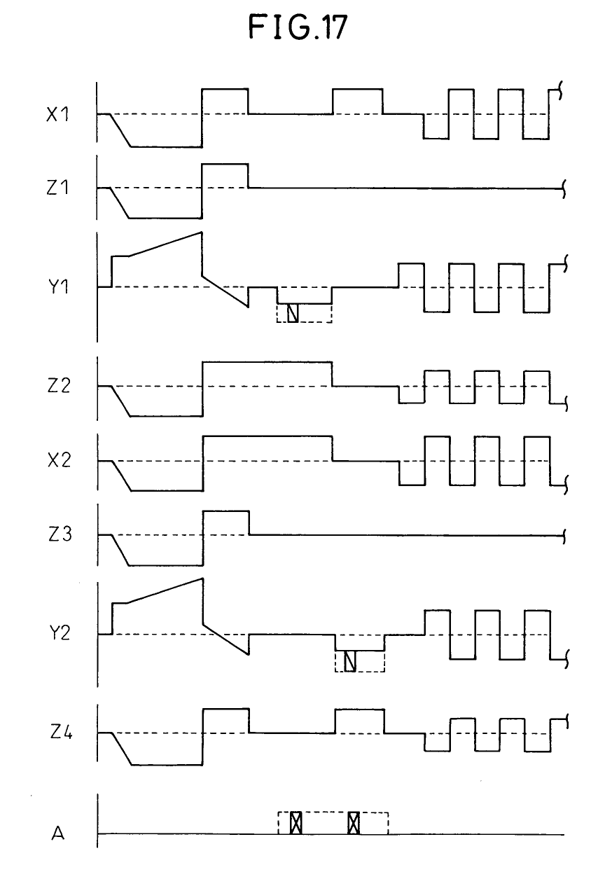

FIG. 16 and FIG. 17 are diagrams showing drive waveforms of the PDP device in the third embodiment, wherein FIG. 16 shows drive waveforms in the odd-numbered field and FIG. 17 shows drive waveforms in the even-numbered field. The drive waveforms to be applied to the X electrode, the Y electrode, and the address electrode are the same as the drive waveforms described in patent document 7 etc., and to the Z electrode provided between the X electrode and the Y electrode between which a discharge is caused to occur, the same drive waveforms as those applied to the Z electrode in the second embodiment are applied, and somewhat different drive waveforms are applied to the Z electrode provided between the X electrode and the Y electrode between which no discharge is caused to occur.

The drive waveforms during the reset period are the same as the drive waveforms in the first and second embodiments and all the cells are put into a uniform state during the reset period.

During the first half of the address period, a predetermined voltage (for example, +Vs) is applied to an odd-numbered X electrode X1 and a Z electrode Z1 in the first group, an even-numbered X electrode X2, an even-numbered Y electrode Y2, and Z electrodes Z2 to Z4 in the second to fourth groups are set to 0 V, and in a state in which a predetermined negative voltage is applied to an odd-numbered Y electrode Y1, the scan pulse 107 is further applied sequentially. In accordance with the application of the scan pulse 107, the address pulse 108 is applied to the address electrode in a cell to be lit. Due to this, a discharge is caused to occur between the odd-numbered Y electrode Y1 to which the scan pulse has been applied and the address electrode to which the address pulse has been applied, and with this as a trigger, a discharge is caused to occur between the odd-numbered X electrode X1 and the odd-numbered Y electrode Y1 and between the Z electrode Z1 in the first group and the odd-numbered Y electrode Y1. Due to this address discharge, negative wall charges are formed in the vicinity of the odd-numbered X electrode X1 and the Z electrode Z1 in the first group (at the surface of the dielectric layer) and positive wall charges are formed in the vicinity of the odd-numbered Y electrode Y1. As no address discharge is caused to occur in a cell to which neither scan pulse nor address pulse is applied, the wall charges at the time of reset are maintained. During the first half of the address period, the above-mentioned operation is carried out by sequentially applying the scan pulse to all of the odd-numbered Y electrodes Y1.

During the second half of the address period, a predetermined voltage is applied to the even-numbered X electrode X2 and the Z electrode Z3 in the third group, the odd-numbered X electrode X1, the odd-numbered Y electrode Y1, and Z electrodes Z1, Z2, and Z4 in the first, second, and fourth groups are set to 0 V, and in a state in which a predetermined negative voltage is applied to the even-numbered Y electrode Y2, the scan pulse 107 is further applied sequentially. In accordance with the application of the scan pulse 107, the address pulse 108 is applied to the address electrode in a cell to be lit. Due to this, a discharge is caused to occur between the even-numbered Y electrode Y2 to which the scan pulse has been applied and the address electrode to which the address pulse has been applied, and with this as a trigger, a discharge is caused to occur between the even-numbered X electrode X2 and the even-numbered Y electrode Y2 and between the Z electrode Z3 in the third group and the even-numbered Y electrode Y2. Due to this address discharge, negative wall charges are formed in the vicinity of the even-numbered X electrode X2 and the Z electrode Z3 in the third group and positive wall charges are formed in the vicinity of the even-numbered Y electrode Y2. During the second half of the address period, the above-mentioned operation is carried out by sequentially applying the scan pulse to all of the even-numbered Y electrodes Y2.

In the above-mentioned manner, addressing of the display lines between the odd-numbered X electrode X1 and the odd-numbered Y electrode Y1 and between the even-numbered X electrode X2 and the even-numbered Y electrode Y2, that is, addressing of the odd-numbered display lines is completed. In a cell in which the address discharge has been caused to occur, positive wall charges are formed in the vicinity of the odd-numbered Y electrode Y1 and the even-numbered Y electrode Y2 and negative wall charges are formed in the vicinity of the odd-numbered X electrode X1, the even-numbered X electrode X2, and the Z electrodes Z1 and Z3 in the first and third groups.

During the sustain discharge period, first the negative sustain discharge pulse 121 having the voltage −Vs is applied to the odd-numbered X electrode X1, a positive sustain discharge pulse 123 having the voltage +Vs is applied to the odd-numbered Y electrode Y1, and the pulse 122 having the voltage −Vz is applied to the Z electrode Z1 in the first group. To the even-numbered X electrode X2 and the even-numbered Y electrode Y2, 0 V is applied. During the sustain discharge period, 0 V is applied to the Z electrodes Z2 and Z4 in the second and fourth groups. At the odd-numbered X electrode X1, the voltage due to the negative wall charges is added to the voltage −Vs, at the odd-numbered Y electrode Y1, the voltage due to the positive wall discharges is added to the voltage +Vs, and at the Z electrode Z1 in the first group, the voltage due to the negative wall charges is added to the voltage −Vz, and a large voltage is applied between them. Due to this, as explained in the second embodiment, a slight discharge is first caused to start across the small distance between the Z electrode Z1 in the first group and the odd-numbered Y electrode Y1 and with this as a trigger, a transition takes place to a discharge across the large distance between the odd-numbered X electrode X1 and the odd-numbered Y electrode Y1. At the end of this discharge, positive wall charges are formed in the vicinity of the odd-numbered X electrode X1 and the Z electrode Z1 in the first group and negative wall charges are formed in the vicinity of the odd-numbered Y electrode Y1.

The voltage Vs is applied to the odd-numbered Y electrode Y1, 0 V is applied to the Z electrode Z2 in the second group, the voltage due to the positive wall charges is added at the odd-numbered Y electrode Y1, and thus the voltage between the odd-numbered Y electrode Y1 and the Z electrode Z2 in the second group becomes high, however, the voltage applied to the Z electrode Z2 in the second group is 0 V, and no wall charges are formed at the Z electrode Z2 in the second group, therefore, the voltage due to the wall charges is not added and, therefore, no discharge is caused to occur. Similarly, no discharge is caused to occur between the even-numbered X electrode X2 and the Z electrode Z2 in the second group. Here, it is necessary to set the voltage to be applied to the Z electrode Z2 in the second group to a voltage that does not cause a discharge to occur. However, it is preferable for the voltage to be applied to the Z electrode Z2 in the second group to be lower than the voltage +Vs to be applied to the neighboring odd-numbered Y electrode Y1 and the even-numbered X electrode X2. This is because if a sustain discharge is caused to occur between the odd-numbered X electrode X1 and the odd-numbered Y electrode Y1, these electrons which are able to move start to move from the odd-numbered X electrode X1 to the odd-numbered Y electrode Y1 and if the voltage of the Z electrode Z2 in the second group is the same as the voltage of the odd-numbered Y electrode Y1, the electrons continue to move toward the Z electrode Z2 in the second group as it is, and move as far as the even-numbered X electrode X2. If this happens, the next application of the sustain discharge pulse having the opposite polarity causes an erroneous discharge to occur, resulting in a display error. In contrast to this, as in the present embodiment, if the voltage of the Z electrode Z2 in the second group is reduced to lower than the voltage of the odd-numbered Y electrode Y1, the movement of electrons can be prevented and an erroneous discharge can be prevented from occurring between neighboring display lines.

The above-mentioned conditions similarly apply to the Z electrode Z4 in the fourth group provided between the even-numbered Y electrode Y2 and the odd-numbered X electrode X1.

Next, positive sustain discharge pulses 131 and 137 having the voltage +Vs are applied to the odd-numbered X electrode X1 and the even-numbered Y electrode Y2, negative sustain discharge pulses 133 and 135 having the voltage −Vs are applied to the odd-numbered Y electrode Y1 and the even-numbered X electrode X2, a positive pulse 132 having the voltage +Vz is applied to the Z electrode Z1 in the first group, and a negative pulse 136 having the voltage −Vz is applied to the Z electrode Z3 in the third group. At the odd-numbered X electrode X1 and the Z electrode Z1 in the first group, positive wall charges are formed by the previous sustain discharge as described above and the voltage due to these charges is added to the voltages +Vs and +Vz, respectively, and at the odd-numbered Y electrode Y1, the voltage due to the negative wall charges formed by the previous sustain discharge is added to the voltage −Vs, and a large voltage is applied between them. Further, at the even-numbered X electrode X2 and the Z electrode Z3 in the third group, the negative wall charges at the end of addressing are maintained, and the voltage due to these charges is added to the voltages −Vs and −Vz, respectively, and at the even-numbered Y electrode Y2, the positive wall charges at the end of addressing are maintained, the voltage due to these charges is added to the voltage +Vs, and a large voltage is applied between them. Due to this, a slight discharge is caused to start across the small distance between the Z electrode Z1 in the first group and the odd-numbered Y electrode Y1 and across the small distance between the Z electrode Z3 in the third group and the even-numbered Y electrode Y2, and with this as a trigger, a transition takes place to a discharge across the large distance between the odd-numbered X electrode X1 and the odd-numbered Y electrode Y1 and across the large distance between the even-numbered X electrode X2 and the even-numbered Y electrode Y2. When this discharge comes to an end, negative wall charges are formed in the vicinity of the odd-numbered X electrode X1 and the Z electrode Z1 in the first group, positive wall charges are formed in the vicinity of the odd-numbered Y electrode Y1, positive wall charges are formed in the vicinity of the even-numbered X electrode X2 and the Z electrode Z3 in the third group, and negative wall charges are formed in the vicinity of the even-numbered Y electrode Y2.

At this time, the voltages having the same polarity are applied between the odd-numbered Y electrode Y1 and the even-numbered X electrode X2 and between the odd-numbered Y electrode Y1 and the Z electrode Z1 in the second group and similarly, the voltage having the same polarity is applied between the even-numbered Y electrode Y2 and the odd-numbered X electrode X1, therefore, no discharge is caused to occur. Further, the voltage Vs is applied between the even-numbered Y electrode Y2 and the Z electrode Z4 in the fourth group, however, no discharge is caused to occur, as described above, and the electrons generated in the neighboring cells are prevented from moving, and an erroneous discharge is prevented from occurring.

Again, the negative sustain discharge pulse having the voltage −Vs is applied to the odd-numbered X electrode X1 and the even-numbered Y electrode Y2, the positive sustain discharge pulse having the voltage +Vs is applied to the odd-numbered Y electrode Y1 and the even-numbered X electrode X2, the negative discharge pulse having the voltage −Vz is applied to the Z electrode Z1 in the first group, and the positive sustain discharge pulse having the voltage +Vs is applied to the Z electrode Z3 in the third group. Due to this, as described above, with a discharge between the odd-numbered Y electrode Y1 and the Z electrode Z1 in the first group as a trigger, a sustain discharge is caused to occur between the odd-numbered X electrode X1 and the odd-numbered Y electrode Y1. Further, at the even-numbered X electrode X2 and the Z electrode Z3 in the third group, positive wall charges are formed by the previous sustain discharge and the voltage due to these charges is added to the voltages +Vs and +Vz, respectively, and negative wall charges by the previous sustain discharge are maintained at the even-numbered Y electrode Y2, the voltage due to these charges is added to the voltage −Vs, and a large voltage is applied between them, causing a sustain discharge to occur. After this, by applying the sustain discharge pulse while inverting the polarities, the sustain discharge is caused to occur repeatedly.

As described above, the first sustain discharge is caused to occur only between the odd-numbered X electrode X1 and the odd-numbered Y electrode Y1 and no sustain discharge is caused to occur between the even-numbered X electrode X2 and the even-numbered Y electrode Y2, therefore, the numbers of sustain discharges are made equal to each other by controlling such that the sustain discharge is caused to occur only between the even-numbered X electrode X2 and the even-numbered Y electrode Y2 and that no sustain discharge is caused to occur between the odd-numbered X electrode X1 and the odd-numbered Y electrode Y1.

The drive waveforms in the odd-numbered field are explained as above. As for the drive waveforms in the even-numbered field, the same drive waveform as that in the odd-numbered field is applied to the odd-numbered Y electrode Y1 and the even-numbered Y electrode Y2, the drive waveform applied to the even-numbered X electrode X2 in the odd-numbered field is applied to the odd-numbered X electrode X1, the drive waveform applied to the odd-numbered X electrode X1 in the odd-numbered field is applied to the even-numbered X electrode X2, the drive waveform applied to the Z electrode Z2 in the second group in the odd-numbered field is applied to the Z electrode Z1 in the first group, the drive waveform applied to the Z electrode Z1 in the first group in the odd-numbered field is applied to the Z electrode Z2 in the second group, the drive waveform applied to the Z electrode Z4 in the fourth group in the odd-numbered field is applied to the Z electrode Z3 in the third group, and the drive waveform applied to the Z electrode Z3 in the third group in the odd-numbered field is applied to the Z electrode Z4 in the fourth group.

The PDP device in the third embodiment is explained as above and it is also possible to apply the modification examples explained in the first and second embodiments to the ALIS system PDP device in the third embodiment. For example, it is also possible to incline the edges of the X discharge electrode and the Y discharge electrode in opposition to the Z electrode with respect to the direction in which the Z electrode extends and to apply the drive waveform that applies a narrow pulse to the Z electrode during the sustain discharge period.

As described above, according to the present invention, it is possible to reduce the discharge start voltage without lowering light emission efficiency and to provide a plasma display panel capable of realizing a PDP device of high display quality at a low cost.

We claim:

1. A plasma display panel comprising:
a first substrate; and
a second substrate arranged in opposition to the first substrate and forming a discharge space in which a discharge gas has been sealed between the first substrate and itself,
the first substrate comprising:
a plurality of first bus electrodes and a plurality of second bus electrodes provided by turns, a first discharge electrode provided so as to be connected to each of the first bus electrodes, and a second discharge electrode provided so as to be connected to each of the second bus electrodes, and
the second substrate comprising:
a plurality of third electrodes provided so as to intersect the first and second bus electrodes,
wherein:
the main discharge for a display is caused to occur between the first discharge electrode and the second discharge electrode;
a plurality of fourth electrodes are provided at the portions where the main discharge between the first discharge electrode and the second discharge electrode is caused to occur; and
when seen in the direction perpendicular to the first and second substrates, the first discharge electrode and the second discharge electrode are in opposition to the edge of each of the fourth electrodes and at least one of the distance between the fourth electrode and the first discharge electrode in opposition to each other and the distance between the fourth electrode and the second discharge electrode in opposition to each other changes gradually in a cell.

2. The plasma display panel as set forth in claim 1, wherein at least one of the first discharge electrode and the second discharge electrode has an edge in opposition to the edge of each of the fourth electrodes and extending rectilinearly in a direction different from that in which the edge of each of the fourth electrodes extends.

3. The plasma display panel as set forth in claim 1, wherein at least one of the first discharge electrode and the second discharge electrode has a curved edge whose distance to the edge of each of the fourth electrodes changes gradually.

4. The plasma display panel as set forth in claim 1, wherein the edge of the fourth electrode is parallel to the direction in which the first and second bus electrodes extend.

5. The plasma display panel as set forth in claim 1, wherein:
both of the first discharge electrode and the second discharge electrode have edges whose distance to the edge of each of the fourth electrodes changes gradually; and
the distance between the edges of the first discharge electrode and the second discharge electrode in opposition to each other with the fourth electrode being sandwiched in between also changing gradually.

6. The plasma display panel as set forth in claim 1, wherein:
both of the first discharge electrode and the second discharge electrode have edges whose distance to the edge of each of the fourth electrodes changes gradually; and
the distance between the edges of the first discharge electrode and the second discharge electrode in opposition to each other with the fourth electrode being sandwiched in between being constant.

7. The plasma display panel as set forth in claim 1, wherein the fourth electrode is composed of a fourth bus electrode and a discharge electrode having substantially the same shape as that of the fourth bus electrode.

8. The plasma display panel as set forth in claim 1, wherein the fourth electrode is formed in the same layer as that in which the first and second bus electrodes and the first and second discharge electrodes are formed.

9. The plasma display panel as set forth in claim 1, wherein the fourth electrode is formed in a layer different from that in which the first and second bus electrodes and the first and second discharge electrodes are formed.

10. The plasma display panel as set forth in claim 1, wherein:
the second discharge electrode to be connected to each of the second bus electrodes causes a discharge to occur between itself and one of the first discharge electrodes to be connected to the neighboring first bus electrodes on both sides and between itself and the other first discharge electrode.

11. A plasma display device comprising the plasma display panel as set forth in claim 1 wherein, at the time of a sustain discharge for causing the main discharge to occur for a display, a voltage required to start a discharge is applied across at least one of the distance between the fourth electrode and the first discharge electrode and the distance between the fourth electrode and the second discharge electrode, both distances changing gradually.
